(19) United States
(12) Patent Application Publication
(10) Pub. No.: US 2026/0100022 A1
(43) Pub. Date: Apr. 9, 2026

(54) Training Image Classifiers Using Data Environments for Movable Barrier Operator Systems

(71) Applicant: THE CHAMBERLAIN GROUP LLC, OAK BROOK, IL (US)

(72) Inventors: Casparus Cate, Lombard, IL (US); Benjamin D Hunt, Winfield, IL (US); Nathan J Kopp, Edmonds, WA (US); Rauf Khasianov, Hoschton, GA (US)

(21) Appl. No.: 18/910,386

(22) Filed: Oct. 9, 2024

(51) Int. Cl. G06V 10/764; G06T 11/60; G06V 10/44

(52) U.S. Cl. CPC G06V 10/764; G06T 11/60; G06V 10/44

(57) ABSTRACT

A detection system for a movable barrier operator system or other system can be used to generate a plurality of machine vision classifiers using synthetic and real-world images. The system can receive the plurality of real-world images corresponding to one or more objects. The system can provide a plurality of synthetic images configured to mimic real-world images of the one or more objects. The system may provide an associated category for each of the synthetic and real-world images. The system can extract features from each of the synthetic and real-world images. The system can generate, based on the extracted features and associated category of each of the synthetic and real-world images, the plurality of machine vision classifiers for a machine vision model.

### TECHNICAL FIELD

This disclosure relates to training image classifiers and, more specifically, to training image classifiers using synthetic data environments and/or synthetic images for movable barrier operator systems.

### BACKGROUND

Training machine vision classifiers using synthetic data can be done in video game engines, such as Unity or Unreal. Training data has historically been built up by collecting real world images. Obtaining sufficient data for certain applications, such as movable barrier operator systems creates many technical challenges. Modern systems lack many of the benefits, including technical benefits, of systems described herein.

### SUMMARY

Aspects and advantages of the invention in accordance with the present disclosure will be set forth in part in the following description, or may be obvious from the description, or may be learned through practice of the technology.

In accordance with an embodiment, a method for generating a plurality of machine vision classifiers using synthetic and real-world images is provided. The method includes receiving, via a data interface, a plurality of real-world images corresponding to one or more objects; providing a plurality of synthetic images configured to mimic real-world images of the one or more objects, wherein a subset of the plurality of synthetic images comprises a simulated image condition configured to modify a respective synthetic image relative to an unmodified synthetic image; providing an associated category for each of the synthetic and real-world images; extracting features from each of the synthetic and real-world images; and generating, based on the extracted features and associated category of each of the synthetic and real-world images, the plurality of machine vision classifiers for a machine vision model.

In accordance with another embodiment, a system for generating a plurality of machine vision classifiers using synthetic and real-world images is provided. The system includes a data interface configured to receive a plurality of real-world images corresponding to one or more objects; a non-transitory computer-readable storage storing machine-executable instructions; and a hardware processor in communication with the computer-readable storage, wherein the instructions, when executed by the hardware processor, are configured to cause the system to: receive, via a data interface, the plurality of real-world images corresponding to one or more objects; provide a plurality of synthetic images configured to mimic real-world images of the one or more objects, wherein a subset of the plurality of synthetic images comprises a simulated image condition configured to modify a respective synthetic image relative to an unmodified synthetic image; provide an associated category for each of the synthetic and real-world images; extract features from each of the synthetic and real-world images; and generate, based on the extracted features and associated category of each of the synthetic and real-world images, the plurality of machine vision classifiers for a machine vision model.

In accordance with another embodiment, a non-transitory computer-readable medium storing instructions which, when executed by a hardware processor are configured to receive, via a data interface, a plurality of real-world images corresponding to one or more objects; provide a plurality of synthetic images configured to mimic real-world images of the one or more objects, wherein a subset of the plurality of synthetic images comprises a simulated image condition configured to modify a respective synthetic image relative to an unmodified synthetic image; provide an associated category for each of the synthetic and real-world images; extract features from each of the synthetic and real-world images; and generate, based on the extracted features and associated category of each of the synthetic and real-world images, a plurality of machine vision classifiers for a machine vision model.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

FIG. 1 shows an example movable barrier operator system for operating a garage door, in accordance with some embodiments.

FIG. 2 shows an example analysis system that includes a detection system, according to some embodiments.

FIGS. 3A-3D show various synthetic images, some with simulated image conditions.

FIG. 4 shows an exemplary process of accessing a trained machine learning model, according to some embodiments.

FIG. 5 shows an example method that can be performed by a system described herein, according to some embodiments.

FIG. 6 is a block diagram that illustrates an example computer system, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions, operations and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Embodiments described herein relate to training machine vision classifiers using synthetic data, such as synthetic images, to train a machine vision learning model and/or generate object inferences from the same. Real-world images may be used in combination with the synthetic images. Challenges exist in generating enough images of certain types of objects for which there are a large variety of types and/or states of that object. For example, in the context of movable barrier operator systems, such as garage door operating systems, obtaining sufficient training data for accurate inference data can be challenging. Additionally or alternatively, training data may be poor quality or otherwise insufficient to train on. This may be due to the subtle differences among model, type, and/or other aspect of a target object. For example, garage door openers (GDOs) have a large number of models that have subtle differences from model to model. Obtaining a sufficient number of images of movable barrier operator systems, including residential garages, warehouses, and/or related products can be challenging. What constitutes as sufficient may be related to the question being answered by the system, such as generating door state classifiers (e.g., “open” or “closed”), providing an occupancy state (e.g., whether a truck is docked at a docking station or not), and/or providing an answer a user's question about a type of object in their garage. A large amount of data is required because to accurately provide these answers may require a variety of images showing camera placements, lighting conditions, props, and/or obstructions (e.g., cars in the way) before training an artificial intelligence (e.g., computer vision) image classifier. The images may be static images and/or video images. The images (e.g., synthetic, real-world) may be helpful in training convoluted neural networks (CNNs), as described below.

Training machine vision classifiers using synthetic data in combination with real-world images can be a helpful solution. Such classifiers may be generated and/or trained in one or more video game engines, such as Unity or Unreal. Training data has historically been built up by collecting real world images. As described herein, synthetic data can be used to generate a classifier that can determine, for example, a make/model of a GDO (garage door opener) in situ in the garage. This data may additionally or alternatively be provided by a user from a ground level. Synthetic data sets can be generated/created from 3D scans of a target physical product (e.g., GDO, transmitters, wall controls, etc.). Additionally or alternatively, the synthetic images can be created from CAD uploads of the outer geometry (e.g., an original equipment manufacturer (OEM) of a product model).

A video gaming engine can used to portray the physical product in a variety of simulated real-life conditions, such as lighting effects, props, occlusions, and/or perspectives. By creating a synthetic data environment, a large dataset of visual images can be created. In some embodiments, these synthetic data can perfectly or near-perfectly simulate what an internet protocol (IP) video camera and/or smartphone might see. This synthetic data can be particularly helpful in training a classifier to recognize certain details of objects, such as a make and/or model, a state of the object (e.g., door is open or closed), and/or position of an object (e.g., vehicle position within a garage). Obtaining large and diverse annotated data set can otherwise be challenging using real-world images alone. The use of video game engines can bypass and/or augment real life images and created data sets for training machine vision models.

An example embodiment can include a door state detector that uses edge detection, dilation, and image subtraction, with Open Source Computer Vision Library (OpenCV2). Such embodiments demonstrate the idea of using an IP camera to determine whether a door was open, a pedestrian door was closed, and/or if a drawer or cabinet in a kitchen or garage was opened. A classifier can be built based, for example, on Unity to determine the door state. Such embodiments can be deployed, for example, on a stationary IP video camera in a garage. Additionally or alternatively, embodiments described herein can be used as a make/model detector.

In some embodiments, users can be connected to the systems described herein to provide additional data. For example, embodiments described herein can generate a robust data set by obtaining from users various data for training. For example, users may provide CAD data and/or high-resolution 3D scanned data to capture outer geometry of an object (e.g., product). This data may include reference to color and/or finish type to more quickly generate a digital model of any product within a collection of target objects. For example, a library of TV remote controls may be built for a particular target technology environment to quickly determine a make and/or model of a TV to, for example, to determine a correct set of infrared (IR) codes. Any time a user is selecting from a large list of possible existing products (e.g., to determine compatibility), such as cars, motorcycles, or products with distinct visual geometry etc., embodiments described herein can provide solutions.

Other methods to build a large dataset may include manual curation via user uploads, as described herein. If enough users submit videos or photos, the images could be annotated and a dataset of such target items can be created. Manual data set generation alone may be time consuming and/or may not cover the entire range of makes and/or models that may be helpful for a set. However, in combination with synthetic images, such real-world images from users can be uniquely powerful at generating trained classifiers.

In some embodiments, 3D scans and/or CAD files can be exported to reconstruct and/or import models into a multi-computer collaborative, networked system. For example, such embodiments can be used to identify a position of a product in a garage, even with a plurality of lighting, ceiling, and/or background conditions. Such conditions can include ceiling joists being exposed, drywalled, rope occluding the GDO, poor lighting conditions, an unusual smartphone camera type, etc.

Using scripting, the system may generate 1000s of images in a real-world raytracing environment. Additionally or alternatively metadata of the conditions and/or the make/model of the target object may be exported to train the classifiers of the machine vision model. The training may be done on GPUs on a local system and/or in the cloud using the dataset of synthetic and/or real-life images. The system can employ a virtual environment to combine aspects of both a training of the model and generation of the dataset. However, in some embodiments, the dataset creation is separate and distinct from training.

In some embodiments, the system uses segmented geometry and/or a trained data set. User-uploaded real-world images and lab-generated and/or web-scraped images can be used to create the dataset and/or train the classifiers. In some embodiments, a classifier can use pictures and/or other data from a remote control, from a wall control, and/or from photo eyes. In some embodiments, the system can take recorded sounds (e.g., a moving GDO) to build a “multimodal” model of a target object. Such multimodal models can be powerful for accuracy, troubleshooting, identifying compatible accessories, and/or recommending a replacement product. Embodiments described herein can achieve one or more of these goals.

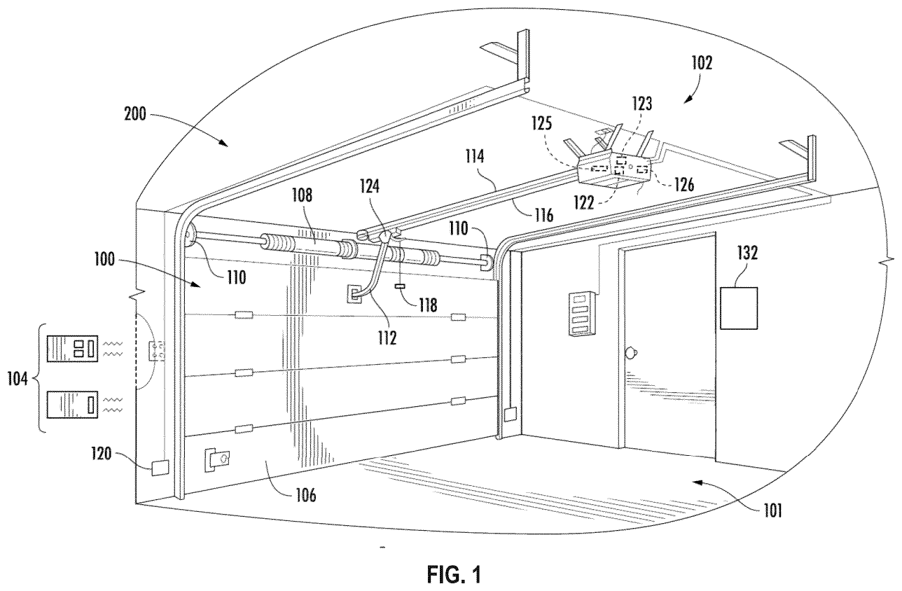

Referring now to FIG. 1, an analysis system 200 is provided that includes a movable barrier operator system 100 for operating a movable barrier, such as a garage door 106, that limits access to a secured area, such as a garage 101. In one embodiment, the movable barrier operator system 100 includes a movable barrier operator, such as a garage door operator 102, and one or more remote controls such as a transmitter 104. The one or more remote controls may also include, for example, a user device such as a smartphone, a laptop computer, a tablet computer, a wearable device, an in-vehicle device such as an infotainment system coupled to an in-vehicle transmitter, a keypad external to the garage 101, a wall control, a visor-mounted remote control, and/or a handheld transmitter such as a key fob. The garage door operator 102 includes an electric motor 122, communication circuitry 123, and a control circuit (including a processor 125 and a memory 126). The processor 125 may include, for example, a microprocessor, a system-on-a-chip, an application specific integrated circuit (ASIC), and/or a field programmable gate array (FPGA). The processor 125 can be one processor or a plurality of processors that are operatively connected. The memory 126 may include, for example, an electrical charge-based storage media such as EEPROM or RAM, or other non-transitory computer readable media such as an optical or magnetic-based storage device. The memory 126 can store information that can be accessed by the processor 125. For instance, the memory 126 (e.g., one or more non-transitory computer-readable storage mediums, memory devices) can include computer-readable instructions that can be executed by the processor 125. The instructions can be software, firmware, or both written in any suitable programming language or can be implemented in firmware or hardware. Additionally, or alternatively, the instructions can be executed in logically and/or virtually separate threads on processor 125. For example, the memory 126 can store instructions that when executed by the processor 125 cause the processor 125 to perform operations such as any of the operations and functions as described herein.

In some embodiments, the garage door operator 102 includes a rail 116 and drive member 114 such as a chain, belt, or screw driven by the motor 122 relative to the rail 116. The electric motor 122 in cooperation with the drive member 114 is operable to move the garage door 106 between open and closed positions. For example, a trolley 124 is coupled to the drive member 114 as well as an arm 112 that is attached to the garage door 106. The motor 122 shifts the trolley 124 back-and-forth along the rail 116 to lift and lower the garage door 106. A release mechanism 118 is coupled to the trolley 124 to allow the garage door 106 to be disconnected from the garage door operator 102 for manual operation such as during a power failure.

The movable barrier operator system 100 includes a drum and cable mechanism 110 that is attached to the garage door 106. The drum and cable mechanism 110 includes a drum and a corresponding cable on each side of the garage door 106. The cable is paid out from and wound up onto the drum when the garage door 106 is respectively lowered and raised. The drum and cable mechanism 110 couples to a counterbalance such as a torsion spring 108 that assists in lifting the weight of the garage door 106 and enables the garage door operator 102 to open or close the garage door 106 via movement of the trolley 124. In some embodiments, an optical device such as a photo eye system 120 senses an obstruction (e.g. object and/or a human) that may be in the path of the garage door 106 as the garage door 106 closes.

With continued reference to FIG. 1, the analysis system 200 may include an imaging system 132 in the secured area. The imaging system 132 may facilitate communication between the garage door operator 102, photo eye system 120, transmitter 104, and/or a remote resource such as a server computer. The imaging system 132 can include one or more imagers configured to image objects, such as objects within the garage 101. For example, the imaging system 132 may generate images, such as real-world images, of one or more objects within the garage 101. The imaging system 132 may be permanently installed in the garage 101. However, in some embodiments, the imaging system 132 can be a mobile device (e.g., a smart device) associated with a user. In some embodiments, the imaging system 132 can be configured to transmit obtained images to another device, such as a computing device (e.g., to a detection system 205).

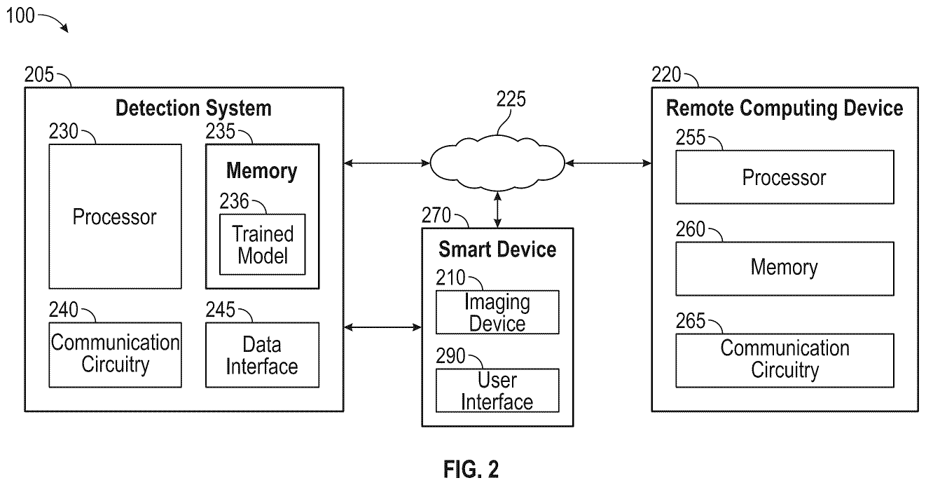

FIG. 2 shows an example analysis system 200 that includes a detection system 205, according to some embodiments. The analysis system 200 can include a detection system 205, a remote computing device 220, a smart device 270, and/or a network 225. The detection system 205 communicates with a remote computing device 220 over a network 225. The network 225 may include, as examples, the internet, a Wi-Fi network, and/or a cellular network. As an example, the detection system 205 communicates over the internet via a Wi-Fi network, such as a Wi-Fi network of a home or a garage (e.g., the garage 101). In another example, the detection system 205 communicates over the internet via wired connection, for example, an ethernet connection.

The detection system 205 includes a processor circuitry 230 operably coupled to a memory 235, communication circuitry 240, and a data interface 245. The memory 235 may be configured to store a trained model 236 and/or associated data/algorithms. The detection system 205 may include and/or be in communication with one or more cameras, such as an imaging device 210 of the smart device 270. The processor circuitry 230 can be configured to operate and control the data interface 245, an associated camera,, and/or the trained model 236.

In some embodiments, the detection system 205 can be configured to generate, receive, and/or store 3D synthetic images of real-world objects, such as garage door openers. For example, the detection system 205 can 1. The detection system 205 can create a 3D Model via a computer-aided design (CAD) operation and/or via a 3D scanning operation. For example, the detection system 205 may use an imaging device, such as a camera (e.g., the imaging device 210, a LIDAR imager) to capture the geometry of an object. In some embodiments, the detection system 205 may be configured to use a plurality of images (e.g., photographs) taken from different angles to reconstruct a 3D model. In some embodiments, the imaging device 210 includes the imaging system 132 described above.

Additionally or alternatively, a user may via the data interface 245 be able to create and/or modify existing 3D images. The memory 235 may identify and/or store geometry (e.g., vertices, edges, faces), textures, materials, colors, and/or animations of the object. The memory 235 may include one or more graphical processing units (GPUs) to generate and/or store the synthetic 3D images. GPUs may be helpful in rendering and/or manipulating 3D models to help the trained model 236 better train data and/or infer objects/types from test images.

The processor 230 is further configured to communicate with remote devices such as the remote computing device 220 via the communication circuitry 240. The communication circuitry 240 may be configured to receive requests to train and/or retrain the trained model 236, and/or draw inferences from the trained model 236. The communication circuitry 240 may cause the data interface 245 to receive data to and/or transmit data from one or more of the smart device 270 and/or the remote computing device 220, such as via the network 225. In some embodiments, the data interface 245 may communicate directly with the smart device 270 and/or the remote computing device 220.

The processor circuitry 230 may cause (e.g., send instructions to) the imaging device 210 to capture images upon the data interface 245 changing the state of the garage door 204. The processor 230 may receive the images from the imaging device 210 and cause the captured image(s) to be stored (e.g., in memory 235 or remotely) and/or process them. The images may include real-world images and/or synthetic images.

The communication circuitry 240 is configured to communicate with remote devices such as the remote computing device 220, peripheral devices, and remote controls using wired and/or wireless protocols. In embodiments where the imaging device 210 is separate from the detection system 205, the communication circuitry 240 may be configured to communicate with the imaging device 210 directly or via network 225 and remote computing device 220. The detection system 205 may control when the imaging device 210 captures images and may receive images captured by the imaging device 210 and store the images in memory, e.g., memory 235. The communication circuitry 240 may communicate with the imaging device 210 via a wired or wireless connection, for example, one or more of power line communication, ethernet, Wi-Fi, Bluetooth, Near Field Communication (NFC), Zigbee, Z-Wave and the like.

The remote computing device 220 includes a processor 255, memory 260, and communication circuitry 265. The processor 255 is in communication with the memory 260 and communication circuitry 265. The remote computing device 220 may include one or more remote computing devices, such as server computers, user devices (e.g., laptops, smart devices, other user interfaces, etc.), and/or devices disposed in a remote location from the detection system 205. The remote computing device 220 is configured to communicate with the detection system 205 via the network 225. The memory 260 of the remote computing device 220 may store one or more algorithms for processing images captured by the imaging device 210 and/or stored in memory 260. In some embodiments, the memory 235 additionally or alternatively includes such algorithms.

For example, the memory 235 may store data and/or algorithms configured to control and/or generate the trained model 236. The memory 235 may be configured to store one or more layers for a convoluted neural network (CNN), such as those in the layered input 604 described below.

The smart device 270 includes a processor 275, memory 280, communication circuitry 285, and a user interface 290. The smart device 270 may include, as examples, a smartphone, smartwatch, wearable device, and tablet computer or personal computer. In some embodiments, the smart device 270 includes a smartphone configured to allow a user to capture real-world images of the certain parts, such as a garage door opener (GDO), that the detection system 205 can be configured to identify. The user interface 290 may be configured to receive a user input that causes the smart device 270 to carry out one or more commands described herein. The user interface 290 may include, for example, at least one of a touchscreen, a microphone, a mouse, a keyboard, a speaker, an augmented reality interface, or a combination thereof. The processor of the smart device 270 may instantiate one or more applications, for example, a client application for controlling the detection system 205 and/or the imaging device 210. The smart device 270 may communicate with the detection system 205 and/or the remote computing device 220 via associated communication circuitry 240, 265 (and/or via the data interface 245) to carry out requests from a user. The communication circuitry 285 of the smart device 270 may communicate with the detection system 205 via the network 225 and the remote computing device 220, for example, to send real-world images to the detection system 205. The smart device 270 may communicate control commands to the detection system 205 via a remote computing device 220 associated with the instantiated application and/or detection system 205 or via network 225.

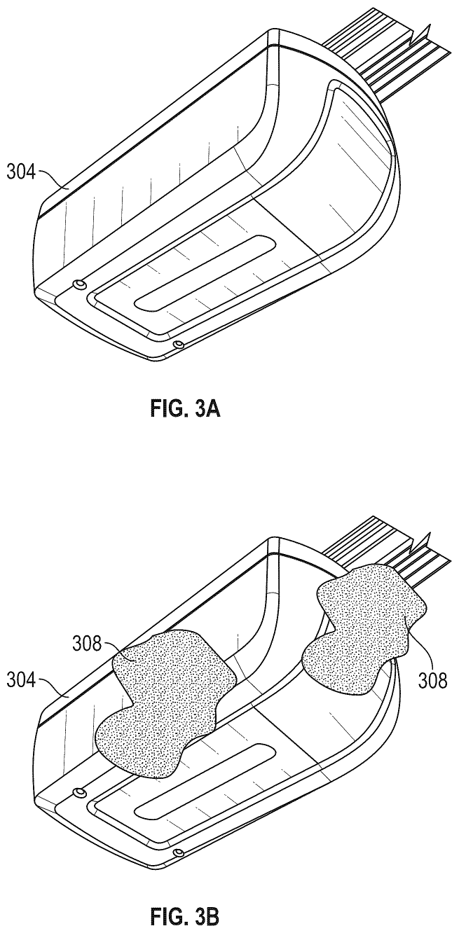

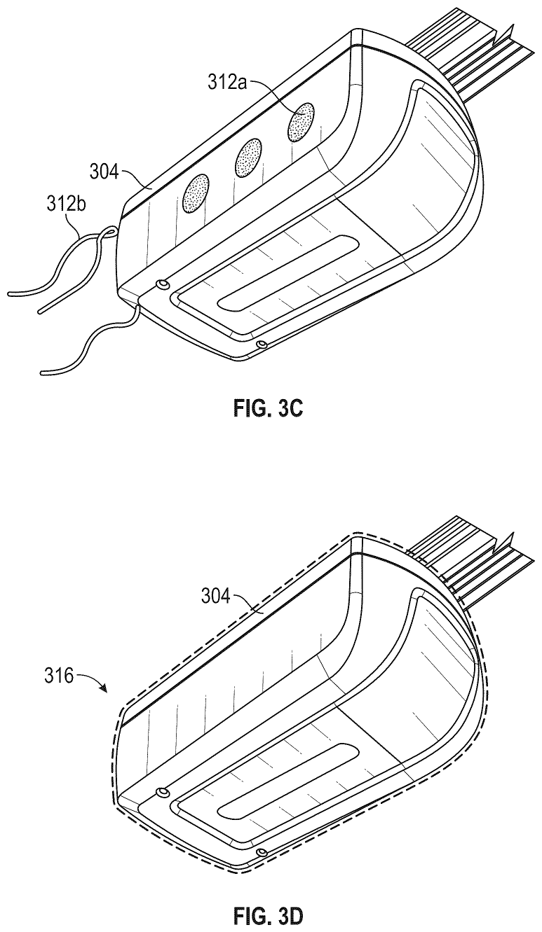

FIGS. 3A-3D show various synthetic images 304, some with simulated image conditions. FIG. 3A shows an original synthetic image 304. The synthetic image 304 shown can be a garage door opener (GDO). However, other objects are possible. FIG. 3B shows the example synthetic image 304 with two occlusions 308. The occlusions 308 can be of any kind, including color occlusions (e.g., solid, gradient, patterned), object occlusions (e.g., foreground, dynamic, partial), environmental occlusions (e.g., fog, smoke, rain, snow, lighting, shadows), synthetic occlusions (e.g., random noise, artificial patterns, text), and/or other occlusions.

FIG. 3C shows the synthetic image 304 with one or more props 312a, 312b. The first props 312a can correspond to a first set of elements, such as buttons. The second props 312b can correspond to a second set of elements, such as wires. Other props as possible. FIG. 3D shows an example modified lighting effect 316 on the synthetic image 304. By modifying the lighting effect 316 of one or more aspects of the synthetic image 304 can make the synthetic image 304 appear more life-like (e.g., more like a real-world image). A combination of occlusions 308, props 312a, 312b, lighting effects 316, and/or other modifications can be effective at simulating real-world objects to grow a more robust and reliable training data set for better training of the machine vision model (e.g., the trained model 236).

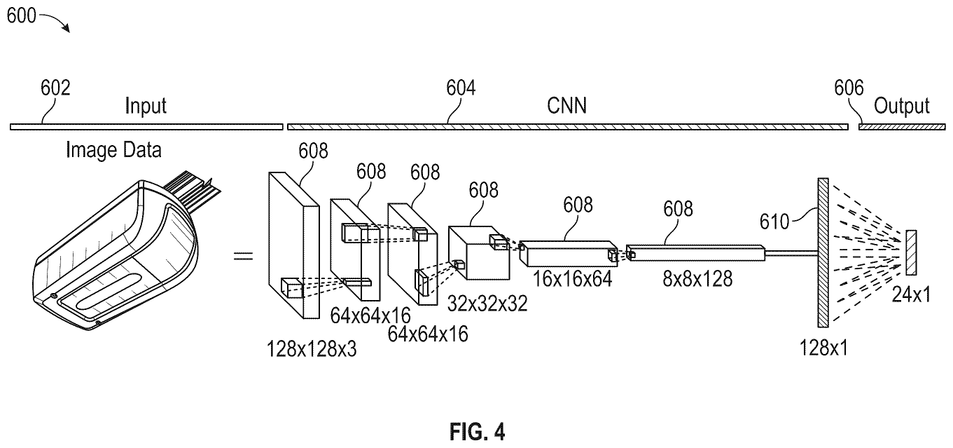

FIG. 4 shows an exemplary process of accessing a trained machine learning model, according to some embodiments. After images of the samples have been captured as described above, these images may be processed using the trained machine learning model 236. This process may be done automatically in response to receiving the images captured by the image sensor 102.

The process 600 may include receiving an input 602, passing the input 604 through the trained machine learning model 236, for example, a convolutional neural network (CNN), and receiving an output 606. The input 602 may include one or more images or other tensor, such as those captured by an imaging device (e.g., the imaging device 210). The trained machine learning model 236 receives the input 602 and passes it to one or more model layers 608. In some examples, the one or more model layers 608 may include hidden layers and a plurality of convolutional layers that “convolve” with a multiplication or other dot product. Additional convolutions may be included, such as pooling layers, fully connected layers, and normalization layers. One or more of these layers may be “hidden” layers because their inputs and outputs are masked by an activation function and a final convolution.

Pooling layers may reduce the dimensions of the data by combining the outputs of neuron clusters at one layer into a single neuron in the next layer. Pooling may be a form of non-linear down sampling. Pooling may compute a max or an average. Thus, pooling may provide a first approximation of a desired feature, such as a predicted device and/or one or more machine vision classifiers. For example, max pooling may use the maximum value from each of a cluster of neurons at a prior layer. By contrast, average pooling may use an average value from one or more clusters of neurons at the prior layer. It may be noted that maximum and average pooling are only examples, as other pooling types may be used. In some examples, the pooling layers transmit pooled data to fully connected layers.

Fully connected layers, such as a fully connected layer 610, may connect every neuron in one layer to every neuron in another layer. Thus, fully connected layers may operate like a multi-layer perceptron neural network (MLP). A resulting flattened matrix may pass through a fully connected layer to classify the input 602.

At one or more convolutions, the process 600 may include a sliding dot product and/or a cross-correlation. Indices of a matrix at one or more convolutions or model layers 608 may be affected by weights in determining a specific index point. For example, each neuron in a neural network may compute an output value by applying a particular function to the input values coming from the receptive field in the previous layer. A vector of weights and/or a bias may determine a function that is applied to the input values. Thus, as the trained machine learning model 236 proceeds through the model layers 608, iterative adjustments to these biases and weights results in a defined output 606, such as a location, orientation, or the like.

Weights may be applied based on one or more factors. For example, the weight of one or more objects and/or one or more layers within a CNN or other machine learning model may be based on data associated with the images. For example, the model layers 608 can apply a weight (e.g., to an image and/or image type) based on an image type, for example, whether the image is a synthetic or real-world image. For example, a higher weight may be applied to real-world images than to synthetic images. Additionally or alternatively, a medium weight may be given to synthetic images with one or more simulated image conditions. The medium weight may be higher than a weight given to synthetic images having no simulated image conditions additionally or alternatively lower than that of a real-world image. In some embodiments, if sufficient simulated image conditions and/or quality thereof is applied to a synthetic image, that image may have a higher associated weight than even to real-world image of the same object. This may be because the synthetic image may portray the image without occlusions and/or with props, whereas the real-world image may be heavily occluded and/or difficult to identify.

Additionally or alternatively, a weighting of an image may be based on metadata associated with the image. For example, some metadata may be particularly instructive to the reliability of the image. For example, if the metadata suggest that the image is of above a threshold resolution, above a threshold lighting condition, above a threshold imager quality, within a threshold range of time (e.g., recent enough), within a threshold range of color saturation, within a threshold geographic location (e.g., so as to be from a trustworthy source, suggesting an authentic specimen of the object), within a threshold range of applied filter metrics, within a threshold range of f-stop, and/or other relevant ranges and/or thresholds associated with any metadata listed herein.

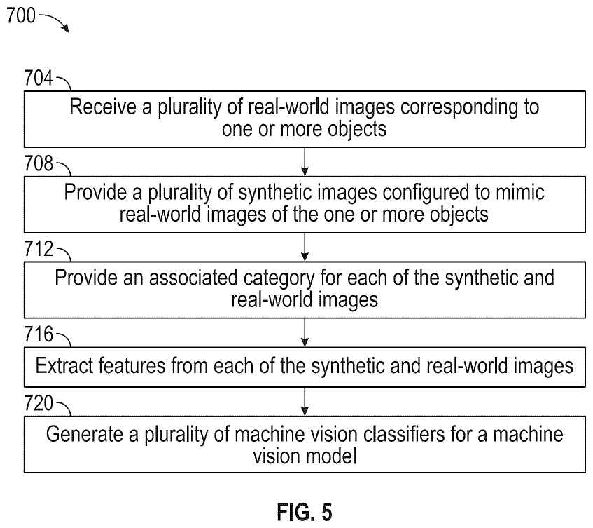

FIG. 5 shows an example method 700 that can be performed by a system described herein, according to some embodiments. The system can include any system described herein, such as the movable barrier operator system 100, the analysis system 200, the detection system 205, and/or other system. At block 704 the system can receive a plurality of real-world images corresponding to one or more objects. The images may be static images and/or video images. The images may be received via a data interface (e.g., the data interface 245). In some embodiments, the data interface includes a wireless data interface. Additionally or alternatively the real-world images may be received from a remote computing device (e.g., the remote computing device 220, the smart device 270) via the wireless data interface.

In some embodiments, the received real-world images may include associated metadata. The metadata can include, for example, an indication of a location, an indication of an imager type (e.g., camera type or camera model), an indication of an imager setting (e.g., portrait mode, landscape mode, f-stop setting, a filter, etc.), a time associated with when the image was captured, a resolution associated with the imager, a lighting level, a color saturation, and/or other relevant metadata. In some embodiments, the system can use to the metadata to accurately weight one image compared to another in terms of the image's reliability. Additionally or alternatively, the metadata can be used to compare one image to another. For example, two images of the same device taken at the same time but with different lighting conditions can be a useful contrast for the trained model to determine how to weight the respective images.

At block 708, the system can provide a plurality of synthetic images configured to mimic real-world images of the one or more objects. The synthetic images can include one or more computer-aided design (CAD) images and/or three-dimensional (3D) scans of physical objects. In some embodiments, a subset of the plurality of synthetic images includes one or more simulated image conditions that are configured to modify at least one of the synthetic images relative to an unmodified synthetic image. In some embodiments, the system can receive the plurality of synthetic images from a computing device (e.g., the remote computing device 220, the smart device 270). Additionally or alternatively, the system may modify each of the synthetic images to generate the subset of the plurality of synthetic images. Modifying each of the one or more of the synthetic images can include applying the simulated image condition to each of the one or more synthetic images. The simulated image condition can include one of a variety of modification effects, such as a lighting effect, a prop within the respective image, a lighting angle, an image angle, a shadowing, an occlusion of a portion of the respective image, and/or another effect.

At block 712, the system can provide an associated category for each of the synthetic and real-world images. The category may include an annotation of the image, such as one or more details associated with the images and/or metadata associated with the images. In some embodiments, providing the associated category for each of the synthetic and real-world images can include assigning each of the synthetic images to a first category and assigning each of the real-world images to a second category. For example, a real-world category may indicate to the trained model that a higher weight (e.g., reliability scoring weight) should be given to those images than to synthetic images. Additionally or alternatively, a synthetic category may indicate to the trained model that a lower weight should be applied to the images of that category. In some embodiments, the system may apply a medium weight to synthetic images having one or more simulated image conditions. The medium weight may be higher than a weight given to synthetic images having no simulated image conditions. Additionally or alternatively the medium weight may have a lower weight than a real-world image. In some embodiments, sufficient simulated image conditions may be applied to a synthetic image that a higher weight should be applied to the synthetic image than even to a related real-world image.

At block 716, the system can extract one or more features from each of the synthetic and real-world images. When extracting the features from each of the synthetic and real-world images, the system may determine a state associated with an object type within at least one of the synthetic and real-world images. For example, the system may determine a degree of deployment associated with the one or more of the synthetic and/or real-world images. By way of example, the system may identify that an object is in a closed state, an open state, a partially closed state, and/or some other state. The degree of deployment could additionally or alternatively refer to a degree to which the object is on/off, functioning/not functioning, new/used, etc. The degree of deployment could be something greater than 0% and/or less than 100% deployed. The object type can include a function of an object shown in the image. Example object types include garage door, garage door opener, remote control, etc.

At block 720, the system can generate the plurality of machine vision classifiers for a machine vision model. Generating the machine vision classifiers may be based on the extracted features and associated category of each of the synthetic and real-world images.

In some embodiments, the system can receive (e.g., via a wireless data interface) a user image. The user image may be obtained from a user via a smart device, such as a smart phone. The system may additionally or alternatively determine a device type associated with an object (e.g., device) indicated in the user image. The system may use a plurality of machine vision classifiers to make this determination. For example, the system may use an inference mode of the trained model to make this determination. Additionally or alternatively, the system may transmit an indication of the device type. The system may transmit this indication of device type back to the user via the remote computing device (e.g., smart phone).

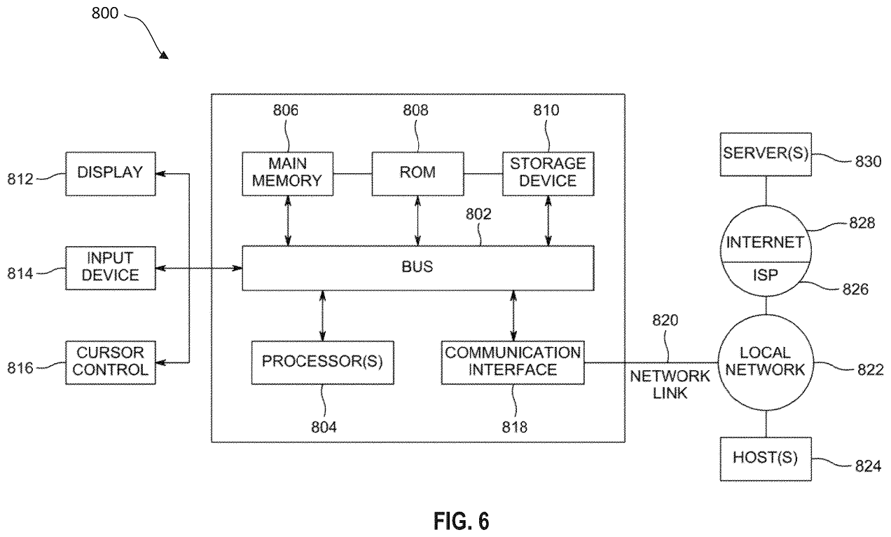

FIG. 6 is a block diagram that illustrates a computer system 800 upon which various embodiments may be implemented. For example, the computer system 800 may be implemented as the data interface 245 (see FIG. 2). The computer system 800 may include a bus 802 or other communication mechanism for communicating information, and a hardware processor, or multiple processors 804 coupled with bus 802 for processing information. The processor(s) 804 may be, for example, one or more general purpose microprocessors.

The computer system 800 also includes a main memory 806, such as a random access memory (RAM), cache and/or other dynamic storage devices, coupled to the bus 802 for storing information and instructions to be executed by the processor 804. The main memory 806 may be used for storing temporary variables or other intermediate information during execution of instructions to be executed by the processor 804. Such instructions, when stored in storage media accessible to the processor 804, render computer system 800 into a special-purpose machine that is customized to perform the operations specified in the instructions.

The computer system 800 further includes a read only memory (ROM) 808 or other static storage device coupled to the bus 802 for storing static information and instructions for the processor 804. A storage device 810, such as a magnetic disk, optical disk, or USB thumb drive (Flash drive), etc., is provided and coupled to bus 802 for storing information and instructions.

The computer system 800 may be coupled via the bus 802 to a display 812, such as a cathode ray tube (CRT) or LCD display (or touch screen), for displaying information to a computer user. An input device 814, including alphanumeric and other keys, is coupled to the bus 802 for communicating information and command selections to the processor 804. Another type of user input device is a cursor control 816, such as a mouse, a trackball, or cursor direction keys for communicating direction information and command selections to the processor 804 and for controlling cursor movement on the display 812. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 800 may include a user interface module to implement a GUI that may be stored in a mass storage device as computer executable program instructions that are executed by the computing device(s). The computer system 800 may further, as described below, implement the techniques described herein using customized hard-wired logic, one or more ASICs or FPGAs, firmware and/or program logic which in combination with the computer system causes or programs the computer system 800 to be a special-purpose machine. According to some embodiments, the techniques herein are performed by the computer system 800 in response to the processor(s) 804 executing one or more sequences of one or more computer readable program instructions contained in the main memory 806. Such instructions may be read into the main memory 806 from another storage medium, such as the storage device 810. Execution of the sequences of instructions contained in the main memory 806 causes the processor(s) 804 to perform the process steps described herein. In alternative embodiments, hard-wired circuitry may be used in place of or in combination with software instructions.

Various forms of computer readable storage media may be involved in carrying one or more sequences of one or more computer readable program instructions to processor for execution. For example, the instructions may initially be carried on a magnetic disk or solid state drive of a remote computer. The remote computer may load the instructions into its dynamic memory and send the instructions over a telephone line using a modem. A modem local to the computer system 800 may receive the data on the telephone line and use an infra-red transmitter to convert the data to an infra-red signal. An infra-red detector may receive the data carried in the infra-red signal and appropriate circuitry may place the data on the bus 802. The bus 802 carries the data to the main memory 806, from which the processor 804 retrieves and executes the instructions. The instructions received by the main memory 806 may optionally be stored on the storage device 810 either before or after execution by the processor 804.

The computer system 800 also includes a communication interface 818 coupled to the bus 802. The communication interface 818 provides a two-way data communication coupling to a network link 820 that is connected to a local network 822. For example, the communication interface 818 may be an integrated services digital network (ISDN) card, cable modem, satellite modem, or a modem to provide a data communication connection to a corresponding type of telephone line. As another example, the communication interface 818 may be a local area network (LAN) card to provide a data communication connection to a compatible LAN (or WAN component to communicated with a WAN). Wireless links may also be implemented. In any such implementation, the communication interface 818 sends and receives electrical, electromagnetic or optical signals that carry digital data streams representing various types of information.

The network link 820 typically provides data communication through one or more networks to other data devices. For example, the network link 820 may provide a connection through the local network 822 to a host computer 824 or to data equipment operated by an Internet Service Provider (ISP) 826. The ISP 826 in turn provides data communication services through the world wide packet data communication network now commonly referred to as an “Internet” 828. The local network 822 and the Internet 828 both use electrical, electromagnetic or optical signals that carry digital data streams. The signals through the various networks and the signals on the network link 820 and through the communication interface 818, which carry the digital data to and from the computer system 800, are example forms of transmission media.

The computer system 800 may send messages and receive data, including program code, through the network(s), the network link 820 and the communication interface 818. In the Internet example, a server 830 might transmit a requested code for an application program through the internet 828, The ISP 826, the local network 822 and communication interface 818. The received code may be executed by the processor 804 as it is received, and/or stored in the storage device 810, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods may be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Further aspects of the invention are provided by one or more of the following example embodiments:

Embodiment 1. A method for generating a plurality of machine vision classifiers using synthetic and real-world images, the method comprising: receiving, via a data interface, a plurality of real-world images corresponding to one or more objects; providing a plurality of synthetic images configured to mimic real-world images of the one or more objects, wherein a subset of the plurality of synthetic images comprises a simulated image condition configured to modify a respective synthetic image relative to an unmodified synthetic image; providing an associated category for each of the synthetic and real-world images; extracting features from each of the synthetic and real-world images; and generating, based on the extracted features and associated category of each of the synthetic and real-world images, the plurality of machine vision classifiers for a machine vision model.

Embodiment 2. The method of embodiment 1, wherein providing the associated category for each of the synthetic and real-world images comprises assigning each of the synthetic images to a first category and assigning each of the real-world images to a second category.

Embodiment 3. The method of any one or more of embodiments 1 or 2, wherein the synthetic images comprise at least one of a computer-aided design (CAD) image or a three-dimensional (3D) scan of a physical object.

Embodiment 4. The method of any one or more of embodiments 1 to 3, further comprising: receiving the plurality of synthetic images; and modifying each of the one or more of the synthetic images to generate the subset of the plurality of synthetic images.

Embodiment 5. The method of embodiment 4, wherein modifying each of the one or more of the synthetic images comprises applying the simulated image condition to each of the one or more synthetic images, the simulated image condition comprising at least one of a lighting effect, a prop within the respective image, or an occlusion of a portion of the respective image.

Embodiment 6. The method of any one or more of embodiments 1 to 5, wherein receiving the plurality of real-world images comprises receiving video imagery of the one or more objects.

Embodiment 7. The method of any one or more of embodiments 1 to 6, wherein the data interface comprises a wireless data interface, and wherein receiving the plurality of real-world images comprises receiving at least one of the real-world images from a remote computing device via the wireless data interface.

Embodiment 8. The method of embodiment 7, wherein the remote computing device comprises a smart device.

Embodiment 9. The method of embodiment 8, further comprising: receiving, via the wireless data interface, a user image; and determining, using the plurality of machine vision classifiers, a device type associated with a device indicated in the user image.

Embodiment 10. The method of embodiment 9, further comprising: transmitting, via the wireless data interface to the smart device, an indication of the device type.

Embodiment 11. The method of any one or more of embodiments 1 to 10, wherein receiving the plurality of real-world images comprises receiving associated metadata for each of the plurality of real-world images, the metadata comprising at least one of the following associated with the corresponding real-world image: an indication of a location, an indication of an imager type, an indication of an imager setting, a time, or a resolution.

Embodiment 12. The method of any one or more of embodiments 1 to 11, wherein extracting the features from each of the synthetic and real-world images comprises determining a state associated with an object type within at least one of the synthetic and real-world images.

Embodiment 13. The method of embodiment 12, wherein the state comprises an indication of a degree of deployment associated with the at least one of the synthetic and real-world images.

Embodiment 14. The method of embodiment 13, wherein the object type comprises a garage door and wherein the degree of deployment corresponds to a degree of openness associated with the garage door.

Embodiment 15. A system for generating a plurality of machine vision classifiers using synthetic and real-world images, the system comprising: a data interface configured to receive a plurality of real-world images corresponding to one or more objects; a non-transitory computer-readable storage storing machine-executable instructions; and a hardware processor in communication with the computer-readable storage, wherein the instructions, when executed by the hardware processor, are configured to cause the system to: receive, via a data interface, the plurality of real-world images corresponding to one or more objects; provide a plurality of synthetic images configured to mimic real-world images of the one or more objects, wherein a subset of the plurality of synthetic images comprises a simulated image condition configured to modify a respective synthetic image relative to an unmodified synthetic image; provide an associated category for each of the synthetic and real-world images; extract features from each of the synthetic and real-world images; and generate, based on the extracted features and associated category of each of the synthetic and real-world images, the plurality of machine vision classifiers for a machine vision model.

Embodiment 16. The system of embodiment 15, wherein the instructions, when executed by the hardware processor, are configured to cause the system further to: receive the plurality of synthetic images; and modify each of the one or more of the synthetic images to generate the subset of the plurality of synthetic images.

Embodiment 17. The system of any one or more of embodiments 15 or 16, wherein the data interface comprises a wireless data interface, and wherein receiving the plurality of real-world images comprises receiving at least one of the real-world images from a remote smart device via the wireless data interface.

Embodiment 18. The system of embodiment 17, wherein the instructions, when executed by the hardware processor, are configured to cause the system further to: receive, via the wireless data interface, a user image; and determine, using the plurality of machine vision classifiers, a device type associated with a device indicated in the user image.

Embodiment 19. The system of embodiment 18, wherein the instructions, when executed by the hardware processor, are configured to cause the system further to: transmit, via the wireless data interface to the smart device, an indication of the device type.

Embodiment 20. A non-transitory computer-readable medium storing instructions which, when executed by a hardware processor, are configured to: receive, via a data interface, a plurality of real-world images corresponding to one or more objects; provide a plurality of synthetic images configured to mimic real-world images of the one or more objects, wherein a subset of the plurality of synthetic images comprises a simulated image condition configured to modify a respective synthetic image relative to an unmodified synthetic image; provide an associated category for each of the synthetic and real-world images; extract features from each of the synthetic and real-world images; and generate, based on the extracted features and associated category of each of the synthetic and real-world images, a plurality of machine vision classifiers for a machine vision model.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A method for generating a plurality of machine vision classifiers using synthetic and real-world images, the method comprising:
receiving, via a data interface, a plurality of real-world images corresponding to one or more objects;
providing a plurality of synthetic images configured to mimic real-world images of the one or more objects, wherein a subset of the plurality of synthetic images comprises a simulated image condition configured to modify a respective synthetic image relative to an unmodified synthetic image;
providing an associated category for each of the synthetic and real-world images;
extracting features from each of the synthetic and real-world images; and
generating, based on the extracted features and associated category of each of the synthetic and real-world images, the plurality of machine vision classifiers for a machine vision model.

2. The method of claim 1, wherein providing the associated category for each of the synthetic and real-world images comprises assigning each of the synthetic images to a first category and assigning each of the real-world images to a second category.

3. The method of claim 1, wherein the synthetic images comprise at least one of a computer-aided design (CAD) image or a three-dimensional (3D) scan of a physical object.

4. The method of claim 1, further comprising:
receiving the plurality of synthetic images; and
modifying each of the one or more of the synthetic images to generate the subset of the plurality of synthetic images.

5. The method of claim 4, wherein modifying each of the one or more of the synthetic images comprises applying the simulated image condition to each of the one or more synthetic images, the simulated image condition comprising at least one of a lighting effect, a prop within the respective image, or an occlusion of a portion of the respective image.

6. The method of claim 1, wherein receiving the plurality of real-world images comprises receiving video imagery of the one or more objects.

7. The method of claim 1, wherein the data interface comprises a wireless data interface, and wherein receiving the plurality of real-world images comprises receiving at least one of the real-world images from a remote computing device via the wireless data interface.

8. The method of claim 7, wherein the remote computing device comprises a smart device.

9. The method of claim 8, further comprising:
receiving, via the wireless data interface, a user image; and
determining, using the plurality of machine vision classifiers, a device type associated with a device indicated in the user image.

10. The method of claim 9, further comprising:
transmitting, via the wireless data interface to the smart device, an indication of the device type.

11. The method of claim 1, wherein receiving the plurality of real-world images comprises receiving associated metadata for each of the plurality of real-world images, the metadata comprising at least one of the following associated with the corresponding real-world image: an indication of a location, an indication of an imager type, an indication of an imager setting, a time, or a resolution.

12. The method of claim 1, wherein extracting the features from each of the synthetic and real-world images comprises determining a state associated with an object type within at least one of the synthetic and real-world images.

13. The method of claim 12, wherein the state comprises an indication of a degree of deployment associated with the at least one of the synthetic and real-world images.

14. The method of claim 13, wherein the object type comprises a garage door and wherein the degree of deployment corresponds to a degree of openness associated with the garage door.

15. A system for generating a plurality of machine vision classifiers using synthetic and real-world images, the system comprising:
a data interface configured to receive a plurality of real-world images corresponding to one or more objects;
a non-transitory computer-readable storage storing machine-executable instructions; and
a hardware processor in communication with the computer-readable storage, wherein the instructions, when executed by the hardware processor, are configured to cause the system to:
receive, via a data interface, the plurality of real-world images corresponding to one or more objects;
provide a plurality of synthetic images configured to mimic real-world images of the one or more objects, wherein a subset of the plurality of synthetic images comprises a simulated image condition configured to modify a respective synthetic image relative to an unmodified synthetic image;
provide an associated category for each of the synthetic and real-world images;
extract features from each of the synthetic and real-world images; and
generate, based on the extracted features and associated category of each of the synthetic and real-world images, the plurality of machine vision classifiers for a machine vision model.

16. The system of claim 15, wherein the instructions, when executed by the hardware processor, are configured to cause the system further to:
receive the plurality of synthetic images; and
modify each of the one or more of the synthetic images to generate the subset of the plurality of synthetic images.

17. The system of claim 15, wherein the data interface comprises a wireless data interface, and wherein receiving the plurality of real-world images comprises receiving at least one of the real-world images from a remote smart device via the wireless data interface.

18. The system of claim 17, wherein the instructions, when executed by the hardware processor, are configured to cause the system further to:
receive, via the wireless data interface, a user image; and
determine, using the plurality of machine vision classifiers, a device type associated with a device indicated in the user image.

19. The system of claim 18, wherein the instructions, when executed by the hardware processor, are configured to cause the system further to:
transmit, via the wireless data interface to the smart device, an indication of the device type.

20. A non-transitory computer-readable medium storing instructions which, when executed by a hardware processor, are configured to:
receive, via a data interface, a plurality of real-world images corresponding to one or more objects;
provide a plurality of synthetic images configured to mimic real-world images of the one or more objects, wherein a subset of the plurality of synthetic images comprises a simulated image condition configured to modify a respective synthetic image relative to an unmodified synthetic image;
provide an associated category for each of the synthetic and real-world images;
extract features from each of the synthetic and real-world images; and
generate, based on the extracted features and associated category of each of the synthetic and real-world images, a plurality of machine vision classifiers for a machine vision model.
